(19) United States
(12) Patent Application Publication
(10) Pub. No.: US 2005/0249573 A1
(43) Pub. Date: Nov. 10, 2005

(54) Screw and corresponding driver

(76) Inventor: Bernard Tanner, Calgary (CA)

Correspondence Address: Ryan W Dupuis;Ade & Company, 1700 360 Main Street, Winnipeg Manitoba, R3C 3Z3, CA

(21) Appl. No.: 10/507,839

(22) PCT Filed: Jan. 20, 2004
(86) PCT No.: PCT/CA04/00065

§ 371 Date: Sep. 15, 2004

Related U.S. Application Data
(60) Provisional application No. 60/441,273, filed on Jan. 21, 2003.

(51) Int. Cl. F16B 23/00

(52) U.S. Cl. 411/403; 411/40; 411/410

(57) ABSTRACT

A screw driver bit (12) and mating screw socket (18) have mating curved side walls (26, 20). The socket includes inner side walls (20) facing inward and the bit includes outer side walls (26) facing outward. The socket and the bit may both be polygonal in cross section, or alternatively, the socket may comprise a plurality of radially extending slots defining the inner side walls at respective free ends thereof while the bit comprises mating ribs defining the outer side walls at the free ends of the ribs. When the side walls of the socket are concave and the side walls of the bit are convex, a single driver bit configuration can mate with many sizes of sockets, including existing Robertson or Phillips designs. Similarly, various sizes of conventional Robertson or Phillips driver bits can be mated with a given socket size according to the present invention.

### FIELD OF THE INVENTION

The present invention relates to the design of a socket of a screw and the corresponding screwdriver bit design for mating engagement with the socket of the screw.

### BACKGROUND

Screws are commonly used as fasteners in all types of applications and accordingly several different designs of sockets and corresponding driver bits are known to be used. One of the most common socket designs is known as a Robertson socket which is generally square in cross section with opposing side walls of the socket being parallel to one another. Another common design of sockets for screws is known as Phillips and takes the form of a set of four radially extending slots lying perpendicular to one another to form a cross in which the slots terminate at respective end walls which comprise flat end surfaces. In each of these socket designs it is common practice to make use of several different size sockets depending upon the size of the screw and accordingly several different size mating driver bits are required in order to prevent stripping of the socket or the driver bit in use.

### SUMMARY

According to one aspect of the present invention there is provided a screw comprising:
a threaded shaft;
a head located at one end of the shaft; and
a socket located within the head for engagement with a driver bit to drive rotation of the shaft;
the socket including plural side walls facing inwardly towards a centre of the socket, each side wall comprising a curved surface tapering towards a common apex of the socket.

The socket may be polygonal in cross section in which the side walls have identical dimensions. Alternatively, the socket may comprise a plurality of radially extending slots defining the side walls at respective free ends of the slots in which the side walls have identical dimensions.

According to a second aspect of the present invention there is provided a screwdriver comprising:
a shaft; and
a bit located at one end of the shaft for mating engagement with a screw to drive rotation of the screw;
the bit including plural side walls facing radially outwardly away from a centre of the bit, each side wall comprising a curved surface tapering towards a common apex of the bit.

The bit may be polygonal in cross section in which the side walls have identical dimensions. Alternatively, the bit may comprise a plurality of radially extending ribs defining the side walls at respective free ends of the ribs in which the side walls have identical dimensions.

According to a further aspect of the present invention there is provided a screwdriver in combination with a screw comprising a threaded shaft, a head located at one end of the shaft and a socket located within the head including plural inner side walls facing inwardly towards a centre of the socket, each inner side wall comprising a curved surface tapering towards a common apex of the socket, the screwdriver comprising:
a shaft; and
a bit located at one end of the shaft for mating engagement with the socket of the screw to drive rotation of the screw;
the bit including plural outer side walls facing radially outwardly away from a centre of the bit, each outer side wall comprising a curved surface tapering towards a common apex of the bit, the curved surfaces of the bit mating with the curved surfaces of the screw.

The socket and the bit may both be polygonal in cross section in which the inner side walls have identical dimensions to one another and the outer side walls have identical dimensions to one another.

When the socket comprises a plurality of radially extending slots defining the inner side walls at respective free ends of the slots in which the inner side walls have identical dimensions to one another, the bit preferably comprises a plurality of radially extending ribs defining the outer side walls at respective free ends of the ribs in which the outer side walls have identical dimensions to one another.

When each rib includes a pair of spaced apart opposed faces defining the rib therebetween, the opposed faces may be parallel to one another, or alternatively may converge towards one another. Accordingly, when each slot includes a pair of spaced apart confronting faces defining the slot therebetween, the confronting faces may be parallel to one another or alternatively, may be converging inwardly towards one another.

The use of convex walls on the driver bit of either square or cross-shaped cross section permits a single driver bit configuration to mate with many sizes of sockets of existing Robertson or Phillips design. Similarly the use of concave walls defining the sockets of the screws permits various sizes of conventional Robertson or Phillips driver bits to be snugly and matingly engaged within a given socket size. The combination of both concave socket walls and convex driver bit walls permits one driver bit to be used with different size sockets within the same set while making a perfect mating engagement therebetween in each instance.

In either configuration of the bit and socket, the socket and the corresponding bit include an equal number of side walls for mating with one another. The particular number of side walls of both the bit and socket may be varied however from 3 to 4 sides as illustrated in the accompanying figures or 5 or more sides as desired while still maintaining the benefits of mating convex and concave surfaces of the bit and socket respectively.

### BRIEF DESCRIPTION OF THE DRAWINGS

In the accompanying drawings, which illustrate exemplary embodiments of the present invention:

FIG. 1 is a top plan view of the socket and head of a first screw according to the present invention.

FIG. 2 is a sectional view along the line 2-2 of FIG. 1.

FIG. 3 is an end view of the corresponding bit of FIG. 2.

FIG. 4 is a top plan view of the socket and head of a second screw according to the present invention.

FIG. 5 is a sectional view along the line 5-5 of FIG. 4.

FIG. 6 is an end view of the corresponding bit of FIG. 5.

FIG. 7 is a top plan view of the socket and head of a third screw according to the present invention.

FIG. 8 is a sectional view along the line 8-8 of FIG. 7.

FIG. 9 is an end view of the corresponding bit of FIG. 8.

FIG. 10 is a top plan view of the socket and head of a fourth screw according to the present invention.

FIG. 11 is a sectional view along the line 11-11 of FIG. 10.

FIG. 12 is an end view of the corresponding bit of FIG. 11.

FIG. 13 is a top plan view of the socket and head of a fifth screw according to the present invention.

FIG. 14 is a sectional view along the line 14-14 of FIG. 13.

FIG. 15 is an end view of the corresponding bit of FIG. 14.

### DETAILED DESCRIPTION

Referring to the accompanying drawings, there is illustrated various designs of a screw 10 used with a screw driver bit 12. The particular configuration of the screw 10 and the driver bit 12 permit various sizes of screws to be driven with a given driver size while also permitting various size drivers to drive a given size screw.

While various embodiments of the screw 10 and driver bit 12 are illustrated herein, the common features of each will first be described. The screw generally includes a head 14 supported on the end of a threaded shaft 16. A socket 18 is located within the head 14 for connection with a driver bit as in conventional screw drivers and screws. The socket 18 includes plural inner side walls 20 which face inwardly towards a centre of the socket to confront opposing ones of the inner side walls 20. Each side wall 20 curves downwardly and inwardly from an outer end at the surface of the head 14 to an inner end at a common apex 22 of the socket. Each side wall thus defines a concave surface of equal size and spacing with respect to the remaining side walls of the socket.

The screw driver bit 12 is supported on the end of a shaft 24 of a screw driver having a handle mounted on the opposing end of the shaft. The bit 12 includes plural outer side walls 26 which face outwardly in respective radial directions away from a central common apex 28 of the bit. Each of the outer side walls 26 curves downwardly and inwardly towards the common apex 28 so as to define a convex outer surface which is suitably arranged for mating with the corresponding inner side walls 20 of a respective socket 18.

Turning now to FIGS. 1 and 7, two embodiments will now be described in further detail. In each of these embodiments the socket is polygonal in cross section having three and four side walls respectively. In further embodiments any number of side walls including five or six for example may also be used. In either instance a socket and a bit are provided having equal numbers of side walls for mating engagement with one another.

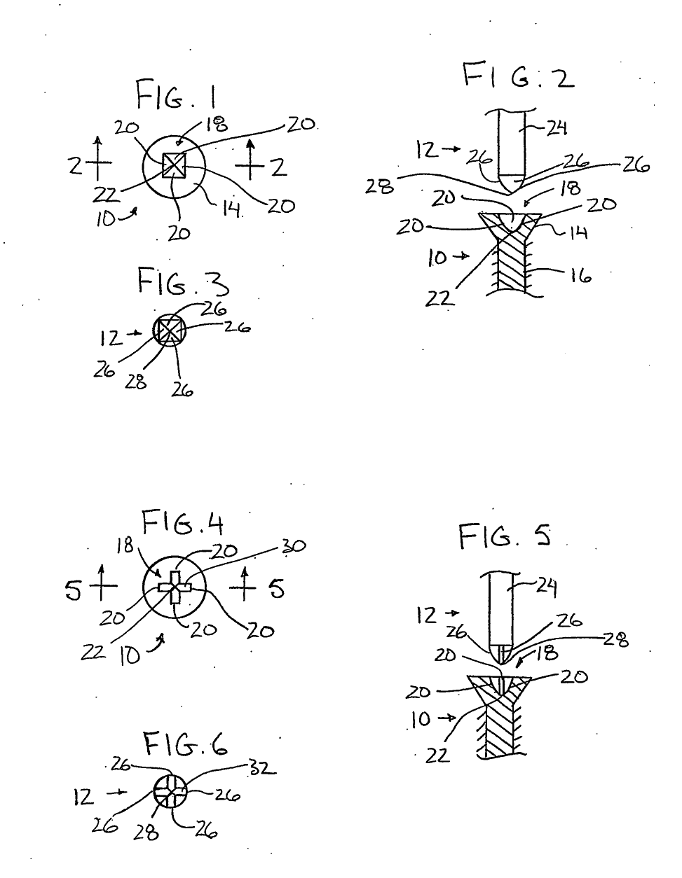

As illustrated in FIGS. 1 through 3, the socket is square in cross section so as to be suitably arranged for mating with conventional Robertson design driver bits. The concave side walls of the socket permit various sizes of Robertson bits to be securely engaged by bottoming out the free end of the driver bit with the inner side walls. Furthermore the arrangement of the bit as illustrated can fit with various size sockets of Robertson design due to the convex surfaces of the outer side walls which ensure engagement with the Robertson socket at the surface of the head 14 of the screw without concern of the free end at the common apex 28 of the bit bottoming out within the socket of a Robertson screw.

As shown in FIGS. 7 through 9 a similar concept to a conventional Robertson design is illustrated in a three-sides configuration. The advantages of mixing and matching different size bits with different size sockets can still be realized with any number of side walls provided that either concave socket walls or convex bit walls are provided.

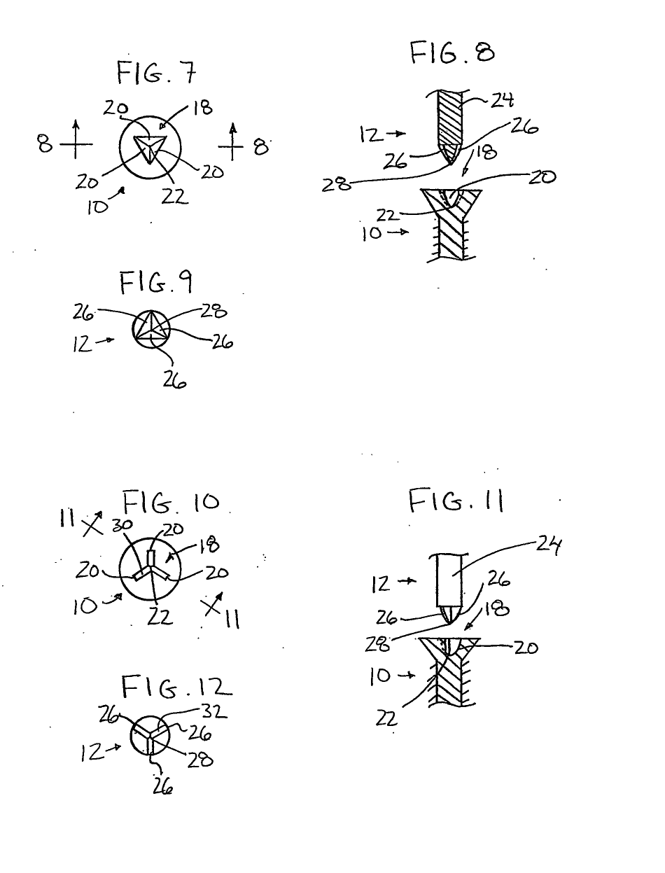

Turning now to the embodiments of FIG. 4 and FIG. 10 a socket design is illustrated in which the socket comprises a plurality of radially extending slots 30 defining the inner side walls 20 at respective free ends of the slots. The confronting walls of each slot, which define the slot therebetween, lie parallel and opposite one another while the side walls 20 at the free ends are concave as noted above. Accordingly the bit 12 comprises a series of radially extending ribs 32 which define the outer side walls 26 at the free ends of the ribs. The opposed walls of each rib, which define the rib therebetween, are also parallel to one another. As noted above the outer side walls 26 are convex for mating with respective walls of the socket.

Turning now to the embodiment of FIGS. 4 through 6 the bit may be provided with four ribs 32 lying perpendicular to one another to form a cross-like configuration for mating with conventional Phillips sockets. Accordingly the socket 18 in this embodiment comprises four of the slots 30 which are perpendicular to one another also in a cross-like configuration for mating with conventional Phillips driver bits. As noted above with regard to mating with conventional Robertson sockets and bits, the concave configuration of the end walls of the socket of FIG. 4 is suitably arranged for fitting with various Phillips bit sizes, and accordingly the concave walls of the bit of the same embodiment is suitably arranged for fitting with various Phillips screw sizes.

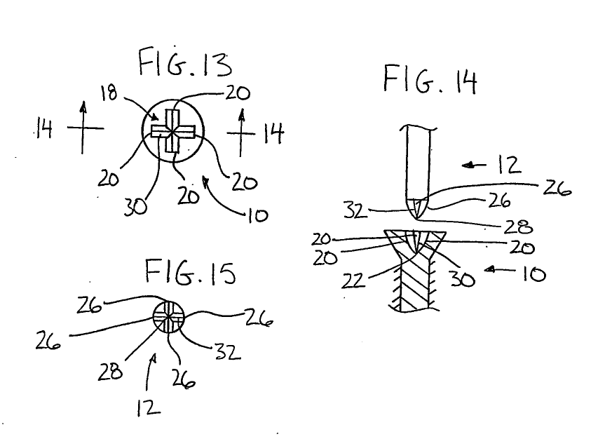

Turning now to FIGS. 10 through 12 a further embodiment using slots 30 in the socket and ribs 32 in the bit is illustrated in which only three ribs or slots are provided. Various size bits may fit with various size sockets as described above with regard to previous embodiments. It is also possible that any other number of ribs, including five or six may be provided for mating with screws having an equal number slots in their respective sockets provided that the concave and convex surfaces of the socket and bit respectively are used to ensure mating engagement between the various sizes of screws and drivers.

Turning now to the embodiment of FIGS. 13 through 15 a socket design is illustrated in which the socket again comprises a plurality of radially extending slots 30 defining the inner side walls 20 at respective free ends of the slots. The confronting walls of each slot, which define the slot therebetween, in this instance are at a straight incline so as to converge to a point at which the confronting walls intersect, while the side walls 20 at the free ends are concave as noted above. Accordingly the bit 12 comprises a series of radially extending ribs 32 which define the outer side walls 26 at the free ends of the ribs. The opposed walls of the rib, which define the rib therebetween matingly converge inwardly to the apex where the opposed walls intersect at the free end of the bit. As noted above the outer side walls 26 are convex for mating with respective walls of the socket. As illustrated, the bit may be provided with four ribs 32 lying perpendicular to one another to form a cross-like configuration for mating with conventional Phillips sockets. Accordingly the socket 18 in this embodiment comprises four of the slots 30 which are perpendicular to one another also in a cross-like configuration for mating with conventional Phillips driver bits.

While various embodiments of the present invention have been described in the foregoing, it is to be understood that other embodiments are possible within the scope of the invention. The invention is to be considered limited solely by the scope of the appended claims.

1. A screw comprising:
a threaded shaft;
a head located at one end of the shaft; and
a socket located within the head for engagement with a driver bit to drive rotation of the shaft;
the socket including plural side walls facing inwardly towards a centre of the socket, each side wall comprising a curved surface tapering towards a common apex of the socket.

2. The screw according to claim 1 wherein the side walls are concave.

3. The screw according to claim 1 wherein the socket is polygonal in cross section, the side walls having identical dimensions.

4. The screw according to claim 1 wherein the socket comprises a plurality of radially extending slots defining the side walls at respective free ends of the slots, the side walls having identical dimensions.

5. The screw according to claim 4 wherein each slot includes a pair of spaced apart confronting faces defining the slot therebetween, the confronting faces lying parallel to one another.

6. The screw according to claim 4 wherein each slot includes a pair of spaced apart confronting faces defining the slot therebetween, the confronting faces converging inwardly towards one another.

7. The screw according to claim 6 wherein the confronting faces intersect one another at an inner end of the slot.

8. A screwdriver comprising:
a shaft; and
a bit located at one end of the shaft for mating engagement with a screw to drive rotation of the screw;
the bit including plural side walls facing radially outwardly away from a centre of the bit, each side wall comprising a curved surface tapering towards a common apex of the bit.

9. The screwdriver according to claim 8 wherein the side walls are convex.

10. The screwdriver according to claim 8 wherein the bit is polygonal in cross section, the side walls having identical dimensions.

11. The screwdriver according to claim 8 wherein the bit comprises a plurality of radially extending ribs defining the side walls at respective free ends of the ribs, the side walls having identical dimensions.

12. The screwdriver according to claim 11 wherein each rib includes a pair of spaced apart opposed faces defining the rib therebetween, the opposed faces lying parallel to one another.

13. The screwdriver according to claim 11 wherein each rib includes a pair of spaced apart opposed faces defining the rib therebetween, the opposed faces converging towards one another at a free end of the bit.

14. The screwdriver according to claim 13 wherein the opposed faces intersect one another at the free end.

15. A screwdriver in combination with a screw comprising a threaded shaft, a head located at one end of the shaft and a socket located within the head including plural inner side walls facing inwardly towards a centre of the socket, each inner side wall comprising a curved surface tapering towards a common apex of the socket, the screwdriver comprising:
a shaft; and
a bit located at one end of the shaft for mating engagement with the socket of the screw to drive rotation of the screw;
the bit including plural outer side walls facing radially outwardly away from a centre of the bit, each outer side wall comprising a curved surface tapering towards a common apex of the bit, the curved surfaces of the bit mating with the curved surfaces of the screw.

16. The combination according to claim 1 wherein the inner side walls of the screw are concave and the outer side walls of the bit are convex.

17. The combination according to claim 1 wherein the socket and the bit are both polygonal in cross section, the inner side walls having identical dimensions to one another and the outer side walls having identical dimensions to one another.

18. The combination according to claim 1 wherein the socket comprises a plurality of radially extending slots defining the inner side walls at respective free ends of the slots, the inner side walls having identical dimensions to one another and wherein the bit comprises a plurality of radially extending ribs defining the outer side walls at respective free ends of the ribs, the outer side walls having identical dimensions to one another.

19. The screwdriver according to claim 18 wherein each rib includes a pair of spaced apart opposed faces defining the rib therebetween, the opposed faces lying parallel to one another and each slot includes a pair of spaced apart confronting faces defining the slot therebetween, the confronting faces lying parallel to one another.

20. The screwdriver according to claim 18 wherein each rib includes a pair of spaced apart opposed faces defining the rib therebetween, the opposed faces converging towards one another at a free end of the bit and each slot includes a pair of spaced apart confronting faces defining the slot therebetween, the confronting faces converging inwardly towards one another.
